(19) United States
(12) Patent Application Publication
(10) Pub. No.: US 2006/0157664 A1
(43) Pub. Date: Jul. 20, 2006

(54) Safety valve having swivel connector

(76) Inventors: G.L. Huff, Afton, TN (US); Mark T. Proffitt, Greeneville, TN (US)

Correspondence Address: MCGUIREWOODS, LLP, 1750 TYSONS BLVD, SUITE 1800, MCLEAN, VA, 22102, US

(21) Appl. No.: 11/331,119

(22) Filed: Jan. 13, 2006

Related U.S. Application Data
(60) Provisional application No. 60/643,675, filed on Jan. 14, 2005.

(51) Int. Cl. F16K 5/00

(52) U.S. Cl. 251/310

(57) ABSTRACT

A safety valve includes a first valve body configured to receive a gas or fluid from a gas or fluid source, the first valve associated with a first structure, and a second valve body configured to provide a gas or fluid to a gas or fluid component, the second valve associated with the second structure. The first valve body and the second valve body are configured and arranged to one of open or close the valve when the first structure moves with respect to the second structure.

### CROSS-REFERENCE TO RELATED APPLICATIONS

This application claims priority under 35 U..C. §119(e) to provisional U.S. Patent Application No. 60/643,675, filed on Jan. 14, 2005, the disclosure of which is expressly incorporated by reference herein in its entirety.

### BACKGROUND OF THE INVENTION

1. Field of the Invention

The invention is directed to a safety valve that connects a source of pressurized gas or fluid to a component and operates in response to an operational movement of a secondary portion of a device. Moreover, the safety valve may provide a swivel connection between the source and the component.

2. Related Art

Many devices require a source of pressurized gas or fluid in order to operate a component that use gas or fluid. These devices typically include a valve situated between the source of the gas or fluid and the component. The valve requires that the user remember to both turn off and turn on the valve in order to disconnect and connect, respectively, the fluid or gas source to the component. This can create a safety hazard in that the user may neglect to turn off the valve and the gas or fluid source may still be connected to the component of the device causing a safety hazard.

Further many devices have the source of pressurized gas or fluid located on a secondary portion of the device that moves or rotates requiring a flexible connection that may be problematic.

Accordingly, there is a need for a safety valve that will automatically disconnect or connect a gas or fluid powered component from the source of the gas or fluid with minimal user interaction. Additionally, there is a need for a swivel connection that provides a safe way to connect to a source of pressurized gas or fluid that swivels or pivots.

### SUMMARY OF THE INVENTION

The invention meets the foregoing need with a valve arrangement that shuts off automatically and further includes a swivel connection, which results in a significant increase in safety and other advantages apparent from the discussion herein.

Accordingly, in one aspect of the invention a safety valve includes a first valve body configured to provide a gas or fluid to a gas or fluid component, the first valve body associated with a first structure, a second valve body configured to receive the gas or fluid from a gas or fluid source, the second valve body associated with a second structure, and the first valve body includes an outlet port that discharges the gas or fluid to the component, and the second valve body includes an input port that receives the gas or fluid from the gas or fluid source, wherein the first valve body and the second valve body are configured and arranged to move with respect to one another to one of connect or disconnect a passageway from the input port to the outlet port when the first structure moves with respect to the second structure.

According to another aspect of the invention a safety valve includes a first valve body configured to provide a gas or fluid to a gas or fluid component, the first valve body associated with a first structure, a second valve body configured to receive the gas or fluid from a gas or fluid source, the second valve body associated with a second structure, and the first valve body includes an outlet port that discharges the gas or fluid to the component, and the second valve body includes an input port that receives the gas or fluid from the gas or fluid source, wherein the first valve body and the second valve body are configured to rotate with respect to one another to one of connect or disconnect a passageway from the input port to the outlet port when the first structure rotates with respect to the second structure.

The first structure and the second structure may be operatively connected and may be configured to support at least one of the gas or fluid component or the gas or fluid source. The safety valve further may include a valve plug configured to one of open or close an opening to one of connect or disconnect the passageway from the input port to the outlet port. The first valve body further may include a receiving aperture, and wherein the valve plug may be arranged within the receiving aperture. The safety valve further may include an actuator that one of rotates or prevents rotation of the valve plug. The actuator may include an engaging pin, and wherein the engaging pin engages a slot within the valve plug. At least one of the actuator and the second valve body may be stationary and the first valve body rotates to one of connect or disconnect the passageway. The first valve body may be stationary and at least one of the second valve body and the actuator rotate to one of open or close the valve. The component may include a gas grill burner, the gas or fluid may include liquefied propane, and the first structure and second structure comprise grill parts.

According to yet another aspect of the invention a method of operating a safety valve includes the steps of connecting a first valve body to a gas or fluid component, the first valve body associated with a first structure, connecting a second valve body to a gas or fluid source, the second valve body associated with a second structure, wherein the first valve body includes an outlet port that discharges the gas or fluid to the component and the second valve body includes an input port that receives the gas or fluid from the gas or fluid source, and moving at least one of the first valve body or second valve body to one of connect or disconnect a passageway from the input port to the outlet port when the first structure moves with respect to the second structure.

The first structure and the second structure may be operatively connected and may be configured to support at least one of the gas or fluid component and the gas or fluid source. The first valve may be stationary and at least one of the second valve body and the actuator rotate to open or close the valve. The component may include a gas grill burner, the gas or fluid may include liquefied propane, the first structure and second structure comprise grill parts.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 shows a perspective view of a valve constructed according to the principles of the invention;

FIG. 2 shows a left side view of the safety valve constructed according to FIG. 1;

FIG. 3 shows a front view of the safety valve constructed according to FIG. 1 and also schematically depicts the arrangement of the gas or fluid source and the component;

FIG. 4 shows a right side view of the safety valve constructed according to FIG. 1;

FIG. 5 shows a top view of the safety valve constructed according to FIG. 1;

FIG. 6 is an exploded perspective view of a specific embodiment of the valve constructed according to the principles of the invention;

FIG. 7 is a side view of the valve of FIG. 6;

FIG. 8 shows an exemplary construction of a valve plug constructed according to the principles of the invention;

FIG. 9 shows a particular aspect of a first main body constructed according to the principles of the invention;

FIG. 10 shows a particular aspect of a second main body constructed according to the principles of the invention; and

FIG. 11 shows the safety valve implemented in a barbecue gas grill according to the principles of the invention.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

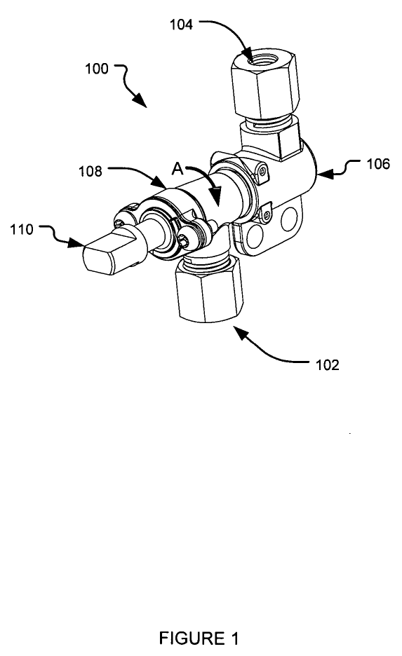

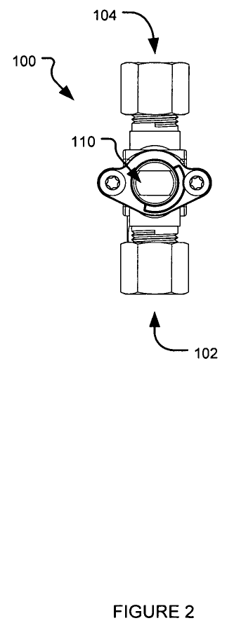

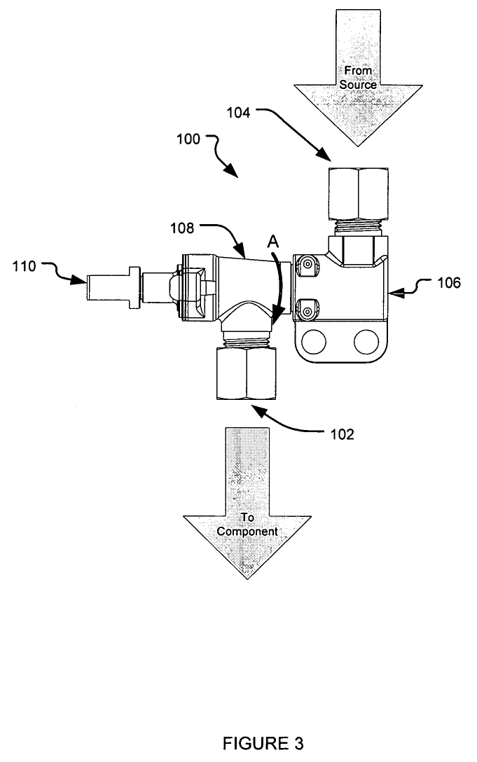

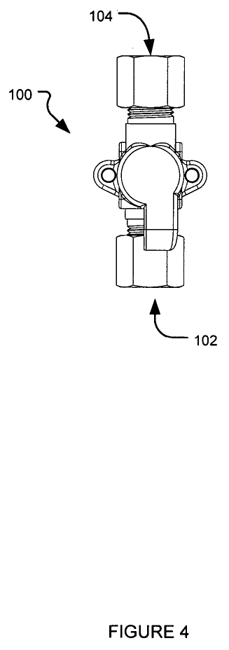

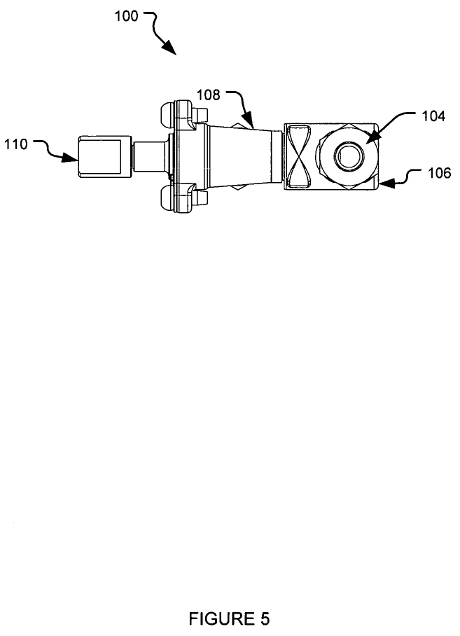

FIG. 1 shows a perspective view of a valve constructed according to the principles of the invention; FIG. 2 shows a left side view of the safety valve constructed according to FIG. 1; FIG. 3 shows a front view of the safety valve constructed according to FIG. 1 and also schematically depicts the arrangement of the gas or fluid source and the component; FIG. 4 shows a right side view of the safety valve constructed according to FIG. 1; and FIG. 5 shows a top view of the safety valve constructed according to FIG. 1. In particular, FIGS. 1-5 show a safety valve 100 that includes an input port 104 and an output port 102. In particular, the input port 104 may be positioned and arranged to receive a source of pressurized gas or fluid. The outlet port 102 is constructed to output the gas or fluid that has been controllably valved via safety valve 100. The safety valve 100 further includes a first main body 108 and a second main body 106. Moreover, safety value 100 may include an actuator 110. However, safety valve 100 may be configured to operate without an actuator.

The safety valve 100 is configured to shut off the flow of the gas or fluid from the input 104 to the output port 102 by swiveling the first main body 108 with respect to the second main body 106 as shown by arrow A. The swiveling is accomplished by securely attaching the second main body 106 to a secondary portion of the device where the source of gas or fluid may be located. Additionally, the actuator 110 may also be connected to the secondary portion where the gas or fluid source is located. The first main body 108, on the other hand, is connected to a portion of the device that may hold the component. Such an arrangement allows for the safety valve 100 to be operated in conjunction with the movement of the secondary portion of the device to provide a higher level of safety by shutting off the valve.

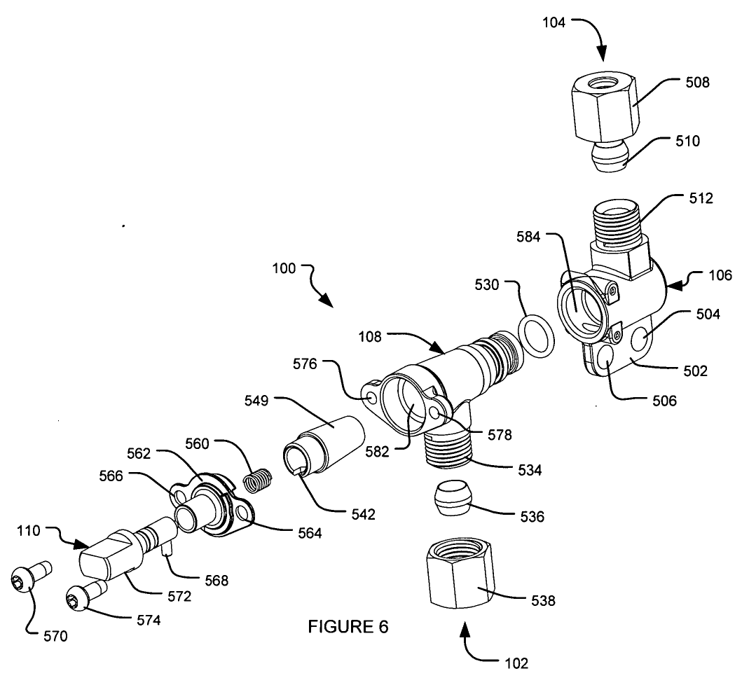

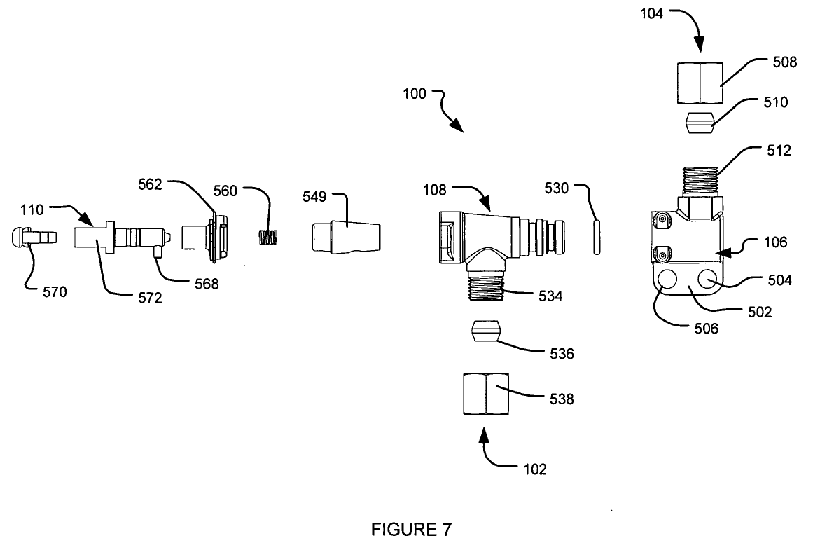

FIG. 6 is an exploded perspective view of a specific embodiment of the valve constructed according to the principles of the invention and FIG. 7 is a side view of the valve of FIG. 6. In particular, the gas or fluid source may be connected to the second main body 106 through the inlet port 104 by any known fastening type connection or connector. In a particular embodiment shown in FIGS. 6 and 7, the gas or fluid source may be connected to the second main body 106 with a securing nut 508. The securing nut 508 may connect a connecting pipe or hose from the gas or fluid source using a ferrule 510 to connect to a threaded pipe connection 512. Accordingly, the gas or fluid source may be connected to the second main body 106 through input port 104 with the securing nut 508, the ferrule 510, and the threaded connector 512 as shown in FIGS. 6 and 7. Of course, it should noted that any type of connection is contemplated for use in the invention to provide a secure and safe connection of the second main body 106 to the gas or fluid source.

Similarly, the fluid output port 102 may be connected to the component via any known connection. In the particular embodiment shown in FIGS. 6 and 7, the output connection via output port 102 may be connected to a securing nut 538, a ferrule 536, which may be connected to a threaded connection 534 to the first main body 108. Again, it should be noted that any type of connection to the output port 102 may be used in the invention.

The first main body 108 may be received into an aperture 584 of the second main body 106. The first main body 108 and the second main body 106 may be formed with any known construction techniques. For example, the first main body 108 and the second main body 106 may be constructed of cast metallic materials, machined from metal stock, or molded from synthetic materials for example only. In the embodiment shown in FIGS. 6 and 7, the first main body 108 and second main body 106 are formed from machining a brass material.

The safety valve 100 further includes a valve plug 549 which is arranged inside the first main body 108. In particular, the valve plug 549 as described below includes an opening therein to provide a pathway connecting the outlet port 102 and inlet port 104. The valve plug 549 may include an actuating slot 542. The actuating slot 542 provides a way in which the valve plug 549 may be rotated inside the first main body 108. An actuator 110 includes an actuating stem 572 and an actuating pin 568. The actuating pin 568 may engage the slot 542 and provide a twisting force to the valve plug 549 to rotate the valve plug 549 within the first main body 108. The actuator 110 is maintained inside the first main body 108 via a cap 562. The cap 562 includes apertures 564, 566, and the cap 562 may be held onto the first main body 108 via fasteners 570, 574 that extend through apertures 564, 566 and into apertures 576, 578 to hold the actuator 110 and valve plug 549 inside the first main body 108. Additionally, the safety valve 100 may include a spring 560 that may force the valve plug 549 to engage an inner surface 582 of the first main body 108 and provide a gas and/or fluid tight construction. The inner surface 582 and/or the valve plug 549 may be coated with a lubricant to further enhance the seal therewith. It should be noted that the actuator may be implemented in many ways only one of which is shown in the figures.

The second main body 106 further includes apertures 504, 506 located on an attachment plate 502 which may be formed with the second main body 106. The purpose of the attachment plate 502 together with the apertures 504, 506 is to arrange and connect the second main body 106 to the secondary portion of the device. Moreover, the actuator 110 is also held by the secondary portion with a corresponding structure (not shown) that engages with the actuating stem 572 and holds the actuating stem 572 such that it moves or is stationary with the second main body 106. Accordingly, when the secondary portion rotates, it rotates the second main body 106 and actuator 110 with respect to the first main body 108 thus opening or closing the valve 100. Moreover, this construction forms a swivel connection between components that rotate with respect to one another.

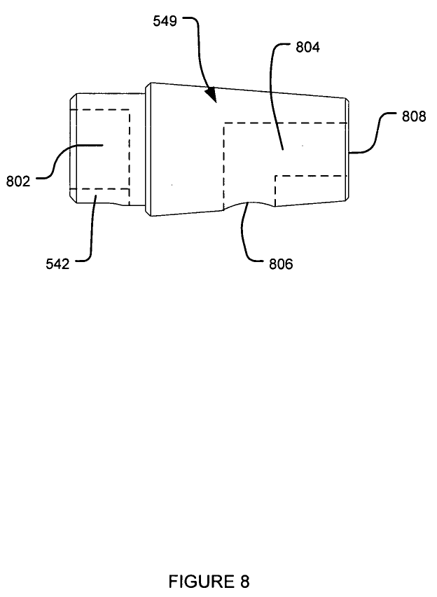

FIG. 8 shows an exemplary construction of the valve plug 549. In particular, the valve plug 549 may include an engagement aperture 802. The engagement aperture 802 allows the actuator 110 and the engaging pin 568 to extend therein. Additionally, the valve plug 549 includes a gas or fluid conduit 804 providing a pathway for the gas or fluid to go from the input port 104 to the outlet port 102. The value plug 549 further includes an aperture 806 and another aperture 808. The aperture 806 providing the valving function of the safety valve 100. In particular, the aperture 806 of the valve plug 549 rotates and may align with a corresponding aperture in the first main body 108 to complete the pathway between the inlet port 104 and the outlet port 102. Alternatively, the aperture 806 may not align with the corresponding aperture in the first main body 108 thereby shutting off or closing the valve of the safety value 100.

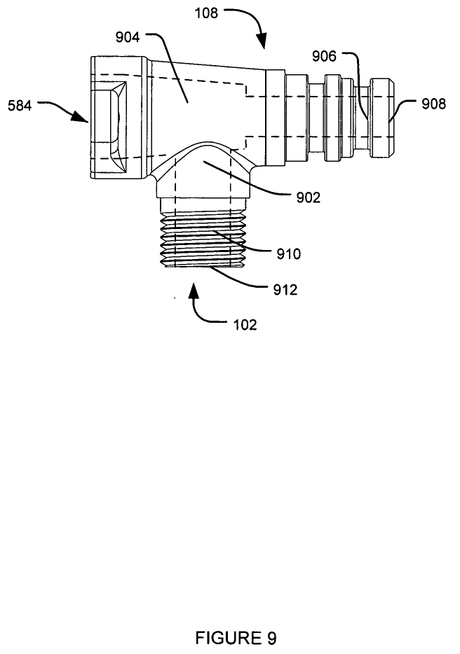

FIG. 9 shows a particular aspect of the first main body 108. In particular, FIG. 9 shows the first main body 108 including the outlet port 102, an aperture 912, a fluid conduit 910, and a chamber 904. The chamber 904 may provide a location for the valve plug 549 to be arranged therein. In particular, the first main body 108 further includes an aperture 902 connecting the conduit 910 and the chamber 904. This aperture 902 is the aperture that may line up with the aperture of the valve plug 549 to provide a valving operation.

The first main body 108 further includes a conduit 906. The conduit 906 extends from the chamber 904 to the very end of the first main body 108 to form an outlet 908 as shown in FIG. 9. Accordingly, the gas or fluid will flow in through aperture 908, conduit 906, and the valve plug 549 that is arranged inside the chamber 904. When the valve plug 549 is rotated such that the aperture 806 of the valve plug 549 is lined up with the aperture 902 of the first main body 108, the gas or fluid will flow down conduit 910 and out the outlet port 102.

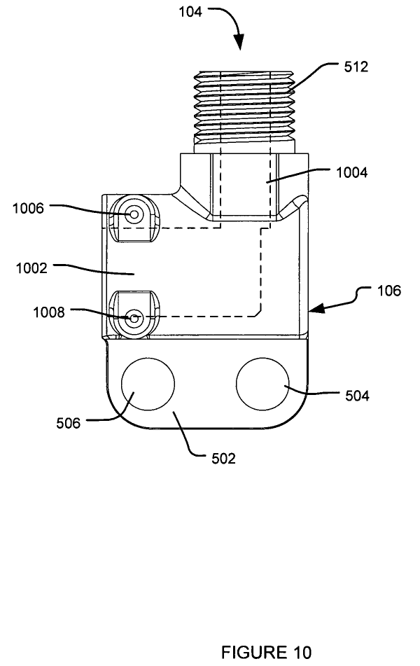

FIG. 10 shows a particular aspect of the second main body 106 construction, including a chamber 1002 that may allow the first main body 108 to extend therein. Accordingly, the chamber 1002 provides an air tight and/or fluid tight connection between the first main body 108 and the second main body 106. Moreover, the chamber 1002 provides a rotatable or swivel connection between the first main body 108 and the second main body 106. The inlet port 104 may allow gas or fluid to flow into a conduit 1004. The gas or fluid traveling down the conduit 1004 may enter the chamber 1002 where the first main body 108 is located. As described above, the first main body 108 may allow the gas or fluid to go into the aperture 908 through conduit 906 into chamber 904 with valve plug 549 and down aperture 902 into conduit 910 and out the outlet port 102 through aperture 912.

The second main body 106 may further include any known type of fasteners 1006, 1008 to hold the first main body 108 and provide an air tight and/or fluid tight connection between the second main body 106 and the first main body 108. Furthermore, the air tight and/or fluid tight connection between the first main body 108 and the second main body 106 may be further enhanced through the use of a gasket such as for example an O-ring 530 as shown in FIG. 6. The O-ring 530 can be constructed of a synthetic material including neoprene or silicone or any other type of material that may form an air tight and/or fluid tight connection.

Accordingly, the safety valve 100 of the invention provides for a valve arrangement that shuts off or limits the flow of a fluid and/or gas through a secondary action and also provides a swiveling action between the connections to a fluid or gas source and the component.

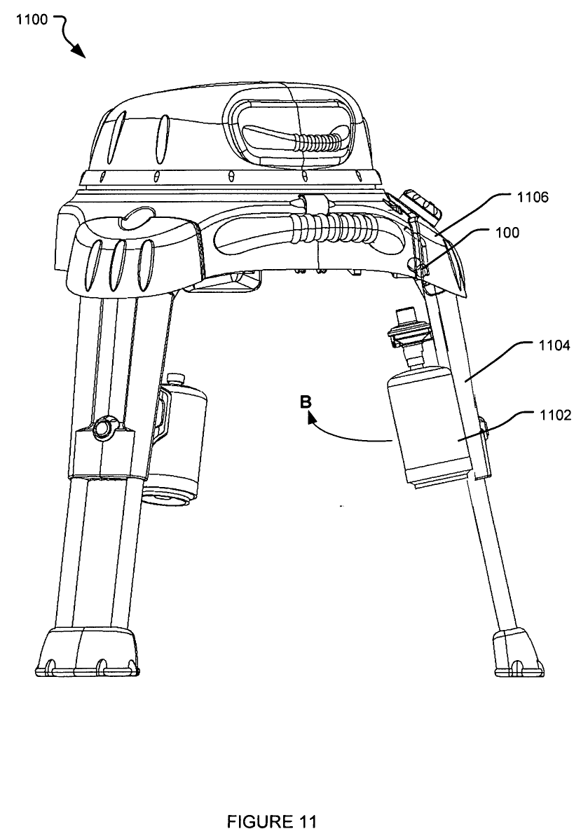

FIG. 11 shows the safety valve implemented in a barbecue gas grill. As shown in FIG. 11 the safety valve 100 may be implemented in a barbecue gas grill 1100 wherein the gas source may be a liquefied propane (LP) tank 1102 and may be located on a leg 1 104 of the barbecue gas grill 1100 such as the barbeque grill described in U.S. patent application Ser. No.: 11/260,692 filed Oct. 28, 2005, the disclosure of which is expressly incorporated by reference herein in its entirety. Also connected to the leg 1104 of the barbecue gas grill 1100 may be the second main body 106 and the actuator 110. Conversely, the first main body portion 108 may be connected to a main body 1106 of the barbecue gas grill 1100 to provide the source of gas or fluid to the gas grill burner (component). In particular, by mounting the second main body 106 and the actuator 110 to the leg 1104 of the barbecue gas grill 1100, when the barbecue gas grill leg 1104 is folded (as shown by arrow B), the leg 1104 rotates and causes the first main body 108 to rotate with respect to the second main body 106. Accordingly, with the safety valve 100 constructed according to the principals described herein, a secondary operation, such as folding a leg 1104 of a barbecue grill 1100, may operate the safety valve 100 to shut off the source of gas or fluid from the component. Accordingly, the user will be less likely to have an accident caused by the device because during the process of placing the barbecue grill in a compact position, the safety valve 100 will shut off the source of gas or fluid.

Additionally it should be noted that the safety valve 100 may be used in numerous applications that require shutting off a source of fluid or gas. These include any application using natural gas, propane, gasoline, or hydraulic fluids in devices for use in the home, farm, construction, transportation, or manufacturing sectors just to name few. For example, the safety valve 100 may shut off natural gas to home appliances such as furnaces in conjunction with the opening of an access panel or shut off hydraulic fluid to farm or construction machines in conjunction with the movement of one or more components.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed is:

1. A safety valve comprising:
a first valve body configured to provide a gas or fluid to a gas or fluid component, said first valve body associated with a first structure;
a second valve body configured to receive the gas or fluid from a gas or fluid source, said second valve body associated with a second structure; and
said first valve body comprises an outlet port that discharges the gas or fluid to the component, and said second valve body comprises an input port that receives the gas or fluid from the gas or fluid source,
wherein said first valve body and said second valve body are configured and arranged to move with respect to one another to one of connect or disconnect a passageway from said input port to said outlet port when the first structure moves with respect to the second structure.

2. The safety valve according to claim 1 wherein the first structure and the second structure are operatively connected and are configured to support at least one of the gas or fluid component or the gas or fluid source.

3. The safety valve according to claim 1 further comprising:
a valve plug configured to one of open or close an opening to one of connect or disconnect the passageway from said input port to said outlet port.

4. The safety valve according to claim 3 wherein said first valve body further comprises a receiving aperture, and wherein said valve plug is arranged within said receiving aperture.

5. The safety valve according to claim 4 further comprising:
an actuator that one of rotates or prevents rotation of said valve plug.

6. The safety valve according to claim 5 wherein said actuator comprises an engaging pin, and wherein said engaging pin engages a slot within said valve plug.

7. The safety valve according to claim 5 wherein at least one of said actuator and said second valve body are stationary and said first valve body rotates to one of connect or disconnect the passageway.

8. The safety valve according to claim 5 wherein said first valve body is stationary and at least one of said second valve body and said actuator rotate to one of open or close the valve.

9. The safety valve according to claim 1 wherein said component comprises a gas grill burner, said gas or fluid comprises liquefied propane, and said first structure and second structure comprise grill parts.

10. A method of operating a safety valve comprising the steps of:
connecting a first valve body to a gas or fluid component, the first valve body associated with a first structure;
connecting a second valve body to a gas or fluid source, the second valve body associated with a second structure, wherein the first valve body comprises an outlet port that discharges the gas or fluid to the component and the second valve body comprises an input port that receives the gas or fluid from the gas or fluid source; and
moving at least one of the first valve body or second valve body to one of connect or disconnect a passageway from said input port to said outlet port when the first structure moves with respect to the second structure.

11. The method of operating a safety valve according to claim 10, wherein the first structure and the second structure are operatively connected and are configured to support at least one of the gas or fluid component and the gas or fluid source.

12. The method of operating a safety valve according to claim 10 wherein the first valve is stationary and at least one of the second valve body and the actuator rotate to open or close the valve.

13. The method of operating a safety valve according to claim 10 wherein the component comprises a gas grill burner, the gas or fluid comprises liquefied propane, the first structure and second structure comprise grill parts.

14. A safety valve comprising:
a first valve body configured to provide a gas or fluid to a gas or fluid component, said first valve body associated with a first structure;
a second valve body configured to receive the gas or fluid from a gas or fluid source, said second valve body associated with a second structure; and
said first valve body comprises an outlet port that discharges the gas or fluid to the component, and said second valve body comprises an input port that receives the gas or fluid from the gas or fluid source,
wherein said first valve body and said second valve body are configured to rotate with respect to one another to one of connect or disconnect a passageway from said input port to said outlet port when the first structure rotates with respect to the second structure.

15. The safety valve according to claim 14 wherein the first structure and the second structure are operatively connected and are configured to support at least one of the gas or fluid component or the gas or fluid source.

16. The safety valve according to claim 15 further comprising:
a valve plug configured to one of open or close an opening to one of connect or disconnect the passageway from said input port to said outlet port.

17. The safety valve according to claim 16 wherein said first valve body further comprises a receiving aperture, and wherein said valve plug is arranged within said receiving aperture.

18. The safety valve according to claim 17 further comprising:
an actuator that one of rotates or prevents rotation of said valve plug.

19. The safety valve according to claim 18 wherein said actuator comprises an engaging pin and said engaging pin engages a slot within said valve plug.

20. The safety valve according to claim 14 wherein said component comprises a gas grill burner, said gas or fluid comprises liquefied propane, said first structure and second structure comprises grill parts.
